(19) United States
(12) Patent Application Publication
(10) Pub. No.: US 2014/0168471 A1
(43) Pub. Date: Jun. 19, 2014

(54) DEVICE WITH VIRTUAL PLENOPTIC CAMERA FUNCTIONALITY

(71) Applicant: RESEARCH IN MOTION LIMITED, Waterloo (CA)

(72) Inventors: Robert Francis LAY, Waterloo (CA); Donald Edward CARKNER, Waterloo (CA)

(73) Assignee: RESEARCH IN MOTION LIMITED, Waterloo (CA)

(21) Appl. No.: 13/719,464

(22) Filed: Dec. 19, 2012

(51) Int. Cl. H04N 5/232

(52) U.S. Cl. CPC H04N 5/232
USPC 348/231.99

(57) ABSTRACT

A device with virtual plenoptic camera functionality is provided. The device comprises: a processor, a memory, an input device, and a camera device configured to capture at least one electronic image, wherein a focal plane of the camera device is adjustable; the processor configured to: control the camera device to capture a plurality of electronic images at a plurality of focal planes; receive, via the input device, input indicating a selection of one or more of the plurality of focal planes; and, store an output electronic image at the memory, the output electronic image comprising one or more of the plurality of electronic images corresponding to one or more selected focal planes.

### FIELD

The specification relates generally to camera devices, and specifically to a device with virtual plenoptic camera functionality.

### BACKGROUND

Plenoptic camera devices generally allow changing a focal plane in an electronic image after the electronic image. However plenoptic camera devices achieve this by utilizing many small lenses between an imaging sensor and a main lens, which effectively captures many small images of a field of view at different angles. The specialized lenses of plenoptic camera devices results in higher camera module cost, and low resolution in final images.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a schematic diagram of a device with virtual plenoptic camera functionality, according to non-limiting implementations.

FIG. 2 depicts a flowchart illustrating a method for implementing virtual plenoptic camera functionality, according to non-limiting implementations.

FIG. 3 depicts front and rear perspective views of the device of FIG. 1, according to non-limiting implementations.

FIG. 4 depicts a top perspective view of the device of FIG. 1 as well as features in a field of view of the device, according to non-limiting implementations.

FIG. 5 depicts electronic images captured when the method of FIG. 2 is implemented in the device of FIG. 1, according to non-limiting implementations.

FIG. 6 depicts the device of FIG. 1, with the electronic images of FIG. 5 stored therein in association with each other, according to non-limiting implementations.

FIG. 7 depicts a selection of focal planes at the device of FIG. 1, according to non-limiting implementations.

FIG. 8 depicts an example output electronic image after two focal planes are selected as in FIG. 7, according to non-limiting implementations.

FIG. 9 depicts the device of FIG. 1, with the electronic images of FIG. 5 and the example output electronic image of FIG. 8 stored therein in association with each other, according to non-limiting implementations.

FIG. 10 depicts a selection of further focal planes at the device of FIG. 1, according to non-limiting implementations.

FIG. 11 depicts an example output electronic image after two further focal planes are selected as in FIG. 10, according to non-limiting implementations.

### DETAILED DESCRIPTION

In this specification, elements may be described as “configured to” perform one or more functions or “configured for” such functions. In general, an element that is configured to perform or configured for performing a function comprises structure for performing the function, or is enabled to perform the function, or is suitable for performing the function, or is adapted to perform the function, or is operable to perform the function, or is otherwise capable of performing the function.

In this specification, elements may be described as configured to “capture” an electronic image. In general, an element that is configured to capture an image is configured to acquire an electronic image, or obtain an electronic image, and the like.

An aspect of the specification provides a device comprising: a processor, a memory, an input device, and a camera device configured to capture at least one electronic image, wherein a focal plane of the camera device is adjustable; the processor configured to: control the camera device to capture a plurality of electronic images at a plurality of focal planes; receive, via the input device, input indicating a selection of one or more of the plurality of focal planes; and, store an output electronic image at the memory, the output electronic image comprising one or more of the plurality of electronic images corresponding to one or more selected focal planes.

The processor can be further configured to control the camera device to capture the plurality of electronic images at the plurality of focal planes in a burst mode.

The processor can be further configured to store the plurality of electronic images at the memory in association with each other and the output electronic image.

The input can indicate a selection of two or more of the plurality of focal planes and the processor can be further configured to: combine the two of the plurality of electronic images respectively corresponding to the selected focal planes to produce the output electronic image, wherein features that are in focus in each of the two of the plurality of electronic images at each of the selected focal planes are also in focus in the output electronic image.

The processor can be further configured to control the camera device to adjust exposure when capturing one or more of the plurality of electronic images to adjust for lighting at each respective focal plane. The processor can be further configured to control the camera device to capture at least two electronic images at respective exposure levels at one or more of the plurality of focal planes.

The processor can be further configured to receive the input, via the input device, one or more of before and after the plurality of electronic images is captured.

The processor can be further configured to apply at least one distortion function to the plurality of electronic images to adjust for distortion at the plurality of focal planes.

The processor can be further configured to capture the plurality of electronic images in a focussing cycle to focus on a given feature in the plurality of electronic images. The plurality of electronic images can comprise a subset of focussing cycle electronic images.

The processor can be further configured to generate the output electronic image by: storing the plurality of electronic images in the memory via a camera application; and, receiving the input, via the input device, in an image adjustment application, different from the camera application, that accesses the plurality of electronic images in the memory.

Another aspect of the specification provides a method comprising: at a device comprising a processor, a memory, an input device, and a camera device configured to capture at least one electronic image, wherein a focal plane of the camera device is adjustable, controlling, via the processor, the camera device to capture a plurality of electronic images at a plurality of focal planes; receiving, via the input device, input indicating a selection of one or more of the plurality of focal planes; and, storing, via the processor, an output electronic image at the memory, the output electronic image comprising one or more of the plurality of electronic images corresponding to one or more selected focal planes.

The method can further comprise controlling the camera device to capture the plurality of electronic images at the plurality of focal planes in a burst mode.

The method can further comprise storing the plurality of electronic images at the memory in association with each other and the output electronic image.

The input can indicate a selection of two or more of the plurality of focal planes, and the method can further comprise: combining two of the plurality of electronic images respectively corresponding to the selected focal planes to produce the output electronic image, wherein features that are in focus in each of the two of the plurality of electronic images at each of the selected focal planes are also in focus in the output electronic image.

The method can further comprise controlling the camera device to adjust exposure when capturing one or more of the plurality of electronic images to adjust for lighting at each respective focal plane. The method can further comprise controlling the camera device to capture at least two electronic images at respective exposure levels at one or more of the plurality of focal planes.

The method can further comprise receiving the input, via the input device, one or more of before and after the plurality of electronic images is captured.

The method can further comprise applying at least one distortion function to the plurality of electronic images to adjust for distortion at the plurality of focal planes.

The method can further comprise capturing the plurality of electronic images in a focussing cycle to focus on a given feature in the plurality of electronic images. The plurality of electronic images can comprise a subset of focussing cycle electronic images.

The method can further comprise generating the output electronic image by: storing the plurality of electronic images in the memory via a camera application; and, receiving the input, via the input device, in an image adjustment application, different from the camera application, that accesses the plurality of electronic images in the memory.

Yet a further aspect of the specification provides a computer program product, comprising a computer usable medium having a computer readable program code adapted to be executed to implement a method comprising: at a device comprising a processor, a memory, an input device, and a camera device configured to capture at least one electronic image, wherein a focal plane of the camera device is adjustable, controlling, via the processor, the camera device to capture a plurality of electronic images at a plurality of focal planes; receiving, via the input device, input indicating a selection of one or more of the plurality of focal planes; and, storing, via the processor, an output electronic image at the memory, the output electronic image comprising one or more of the plurality of electronic images corresponding to one or more selected focal planes. The computer usable medium can comprise a non-transitory computer usable medium.

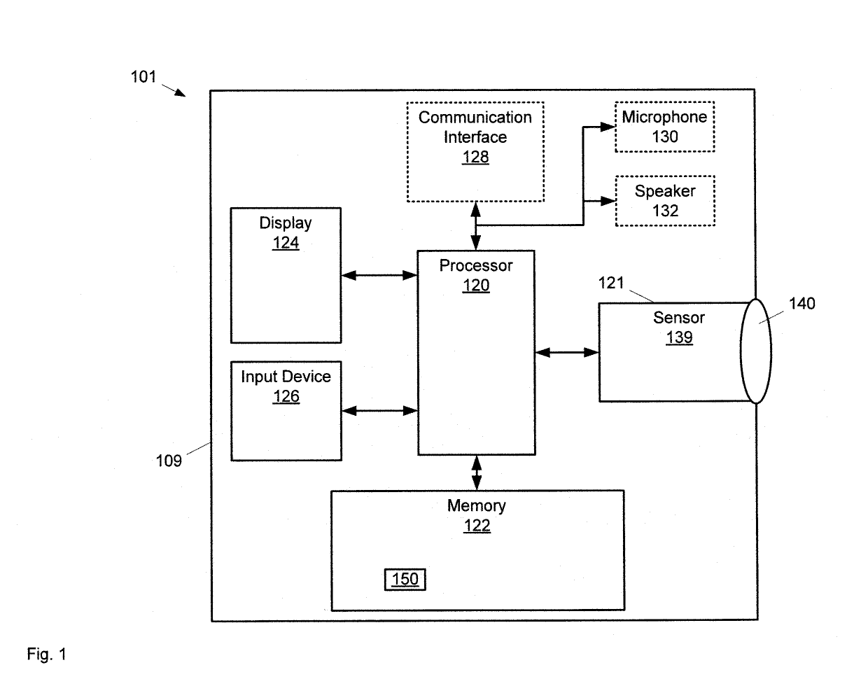

FIG. 1 depicts a device 101 with virtual plenoptic camera functionality, according to non-limiting implementations. Device 101 comprises: a housing 109; and a processor 120 interconnected with a camera device 121, a memory 122, a display 124, and an input device 126, and an optional communications interface 128, an optional microphone 130 and an optional speaker 132. Camera device 121 is configured to capture at least one electronic image and comprises a sensor 139 for capturing at least one electronic image and a lens system 140 for focusing light onto sensor 139, the focused light sensed by sensor 139 for capturing electronic images.

Lens system 140 can comprise one or more lenses and a focusing mechanism. In some implementations, lens system 140 can be modular and/or interchangeable, such that various lenses can be used with device 101. In other implementations, lens system 140 can be fixed but focusable via focusing mechanism. In yet further implementations camera device 121 comprises a sensor module and/or a camera module comprising sensor 139 and lens system 140. In any event, camera device 121 is further focusable via the focusing mechanism such that a focal plane of camera device 121 is adjustable, for example by adjusting lens system 140.

As will be presently explained, processor 120 is generally configured to: control camera device 121 to capture a plurality of electronic images at a plurality of focal planes; receive, via input device 126, input indicating a selection of one or more of the plurality of focal planes; and, store an output electronic image at memory 122, the output electronic image comprising one or more of the plurality of electronic images corresponding to one or more selected focal planes.

Device 101 can be any type of electronic device that can be used in a self-contained manner to capture electronic images via camera device 121. Device 101 includes, but is not limited to, any combination of digital cameras, electronic devices, communications devices, computing devices, personal computers, laptop computers, portable electronic devices, mobile computing devices, portable computing devices, tablet computing devices, laptop computing devices, desktop phones, telephones, PDAs (personal digital assistants), cellphones, smartphones, e-readers, internet-configured appliances and the like.

It is appreciated that FIG. 1 further depicts a schematic diagram of device 101 according to non-limiting implementations. It should be emphasized that the structure of device 101 in FIG. 1 is purely an example, and contemplates a device that can be used for acquiring electronic images, wireless voice (e.g. telephony) and wireless data communications (e.g. email, web browsing, text, and the like). However, while FIG. 1 contemplates a device that can be used for both camera functionality and telephony, in other implementations, device 101 can comprise a device configured for implementing any suitable specialized functions, including but not limited to one or more of camera functionality, telephony, computing, appliance, and/or entertainment related functions.

Housing 109 generally houses processor 120, camera device 121, memory 122, display 124, input device 126, optional communications interface 128, optional microphone 130, optional speaker 132 and any associated electronics. Housing 109 can comprise any combination of metal, plastic, glass and like.

Device 101 comprises at least one input device 126 generally configured to receive input data, and can comprise any suitable combination of input devices, including but not limited to a keyboard, a keypad, a pointing device, a mouse, a track wheel, a trackball, a touchpad, a touch screen and the like. Other suitable input devices are within the scope of present implementations.

Input from input device 126 is received at processor 120 (which can be implemented as a plurality of processors, including but not limited to one or more central processors (CPUs)). Processor 120 is configured to communicate with memory 122 comprising a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of device 101 as described herein are typically maintained, persistently, in memory 122 and used by processor 120 which makes appropriate utilization of volatile storage during the execution of such programming instructions. Those skilled in the art recognize that memory 122 is an example of computer readable media that can store programming instructions executable on processor 120. Furthermore, memory 122 is also an example of a memory unit and/or memory module.

In particular, it is appreciated that memory 122 stores at least one application 150, that, when processed by processor 120, enables processor 120 to: control camera device 121 to capture a plurality of electronic images at a plurality of focal planes; receive, via input device 126, input indicating a selection of one or more of the plurality of focal planes; and, store an output electronic image at memory 122, the output electronic image comprising one or more of the plurality of electronic images corresponding to one or more selected focal planes.

It is yet further appreciated that at least one application 150 is an example of programming instructions stored at memory 122. For example, at least one application 150 can comprise a combination of a camera application and an image adjustment application. In some implementations the camera application and the image adjustment application can be combined, while in other implementations, the camera application and image adjustment application can be distinct from one another. The camera application can be used to capture electronic images and the image adjustment application can be used to generate and store an output electronic image, as described below.

Sensor 139 of camera device 121 generally comprises any device for acquiring electronic images, including but not limited one or more of a camera device, a video device, a CMOS (complementary metal-oxide-semiconductor) image sensor, a CCD (charge-coupled device) image sensor and the like.

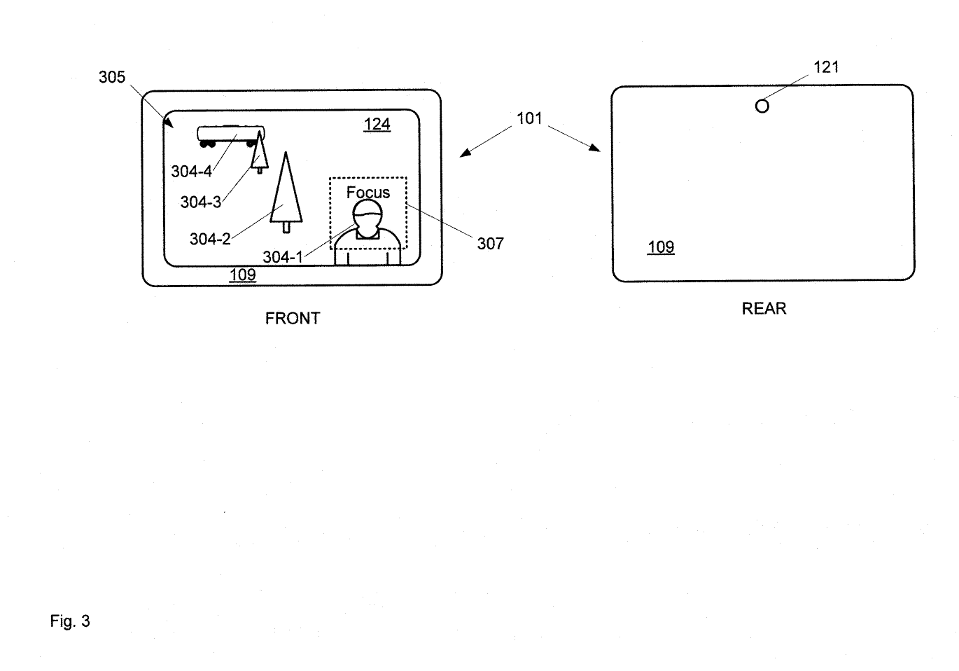

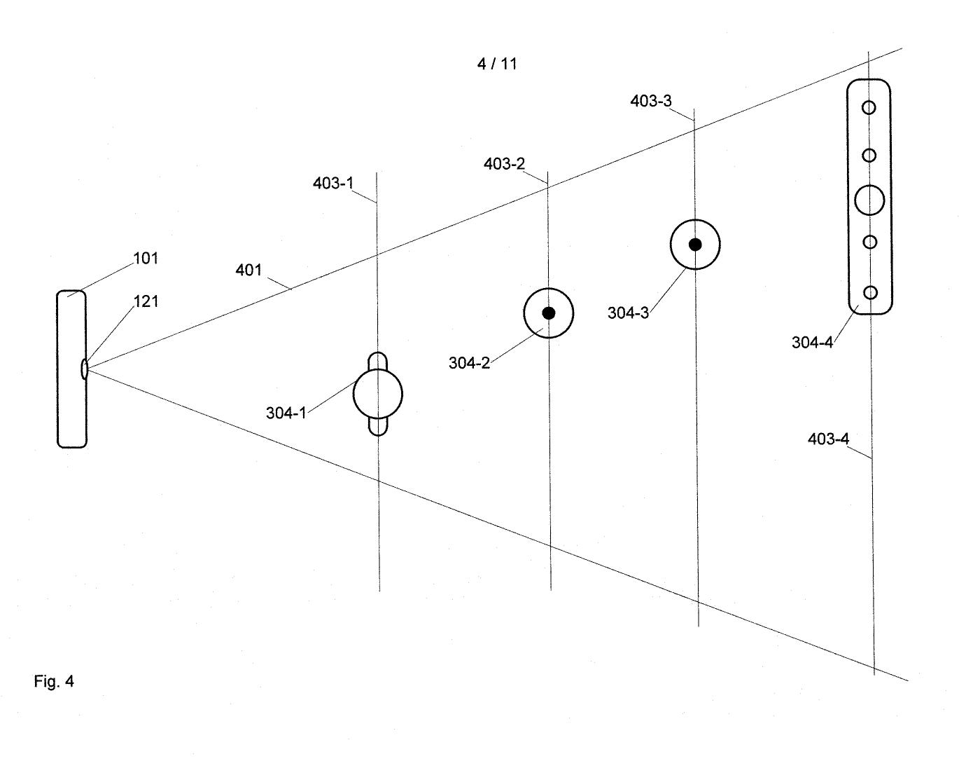

As best understood from FIGS. 3 and 4 described below, in present implementations, camera device 121 is configured to capture images from a field of view facing away from the rear of device 100. However, the placement and/or field of view of camera device 121 are generally non-limiting: for example, camera device 121 could be located to capture images in a field of view adjacent display 124. Indeed, in some implementations, device 100 can comprise more than one camera device 121 and/or more than one sensor similar to sensor 139 and/or more than one lens system similar to lens system 140, for acquiring images at more than one field of view. Further, images captured by camera device 121 can comprise one or more of camera images, video images, video streams and the like.

It is yet further appreciated that, in some implementations, camera device 121 can comprise an infrared sensor such that images comprise electronic infrared images and hence camera device 121 can function in low ambient lighting scenarios.

In addition to one or more lenses, lens system 140 comprises a focussing mechanism for changing the focal plane of camera device 121, including, but not limited to, any combination of voice coil actuators, piezoelectric motors, stepper motors, and the like.

It is further appreciated that processor 120 is configured to control camera device 121 to capture a plurality of electronic images at a plurality of focal planes by controlling camera device 121 to: capture a first electronic image at a first focal plane; adjust a focal plane of camera device 121 by adjusting focussing mechanism; and capture a second electronic image at a second focal plane. As described in further detail below, the process of acquiring a first electronic image, adjusting a focal plane and acquiring at least a second electronic image can be repeated for any given number of focal planes and/or electronic images.

For example, processor 120 can be configured to control camera device 121 to capture the plurality of electronic images at the plurality of focal planes in a burst mode, in which a plurality of electronic images are captured in rapid succession, with a focal plane of camera device 121 being adjusted between each successive capture of an electronic image.

Alternatively, processor 120 can be configured to capture the plurality of electronic images in a focussing cycle to focus on a given feature in the plurality of electronic images, as described in further detail below.

Processor 120 can also be configured to communicate with a display 124, and optionally microphone 130 and a speaker 132. Display 124 comprises any suitable one of or combination of CRT (cathode ray tube) and/or flat panel displays (e.g. LCD (liquid crystal display), plasma, OLED (organic light emitting diode), capacitive or resistive touch screens, and the like). When display 124 comprises a touch screen, it is appreciated that display 124 and input device 126 can be combined into one apparatus. While optional, microphone 130 is configured to receive sound data, and speaker 132 is configured to provide sound data, audible alerts, audible communications, and the like, at device 101. In some implementations, input device 126 and display 124 are external to device 101, with processor 120 in communication with each of input device 126 and display 124 via a suitable connection and/or link.

In optional implementations, as depicted, processor 120 also connects to communication interface 128, which is implemented as one or more radios and/or connectors and/or network adaptors, configured to wirelessly communicate with one or more communication networks (not depicted). It will be appreciated that, in these implementations, communication interface 128 can be configured to correspond with network architecture that is used to implement one or more communication links to the one or more communication networks, including but not limited to any suitable combination of USB (universal serial bus) cables, serial cables, wireless links, cell-phone links, cellular network links (including but not limited to 2G, 2.5G, 3G, 4G+, UMTS (Universal Mobile Telecommunications System), CDMA (Code division multiple access), WCDMA (Wideband CDMA), FDD (frequency division duplexing), TDD (time division duplexing), TDD-LTE (TDD-Long Term Evolution), TD-SCDMA (Time Division Synchronous Code Division Multiple Access) and the like, wireless data, Bluetooth links, NFC (near field communication) links, WiFi links, WiMax links, packet based links, the Internet, analog networks, the PSTN (public switched telephone network), access points, and the like, and/or a combination. When communication interface 128 is configured to communicate with one or more communication networks, communication interface 128 can comprise further protocol specific antennas there for (not depicted).

While not depicted, it is further appreciated that device 101 further comprises one or more power sources, including but not limited to a battery and/or a connection to an external power source, including, but not limited to, a main power supply.

In any event, it should be understood that in general a wide variety of configurations for device 101 are contemplated.

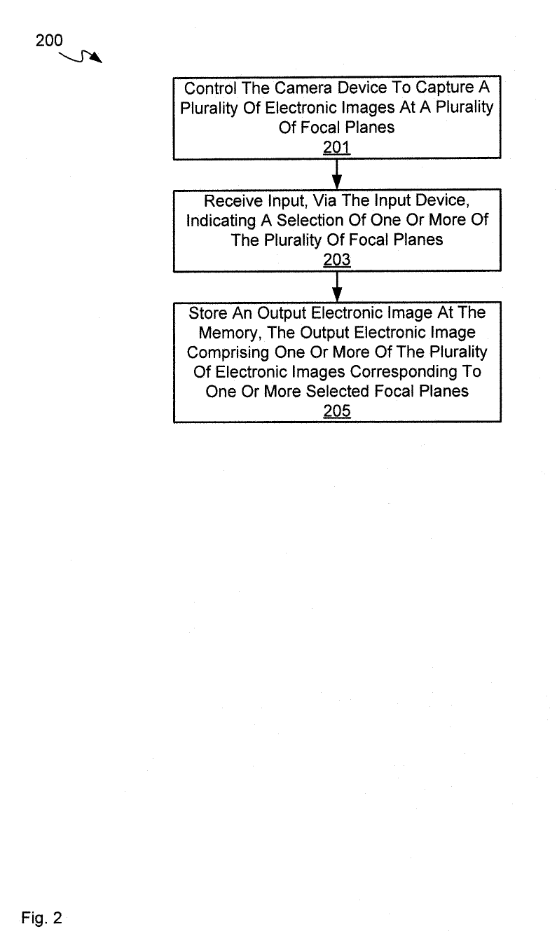

Attention is now directed to FIG. 2 which depicts a flowchart illustrating a method 200 for implementing virtual plenoptic camera functionality at a device, according to non-limiting implementations. In order to assist in the explanation of method 200, it will be assumed that method 200 is performed using device 101. Furthermore, the following discussion of method 200 will lead to a further understanding of device 101 and its various components. However, it is to be understood that device 101 and/or method 200 can be varied, and need not work exactly as discussed herein in conjunction with each other, and that such variations are within the scope of present implementations. It is appreciated that, in some implementations, method 200 is implemented in device 101 by processor 120.

It is to be emphasized, however, that method 200 need not be performed in the exact sequence as shown, unless otherwise indicated; and likewise various blocks may be performed in parallel rather than in sequence; hence the elements of method 200 are referred to herein as “blocks” rather than “steps”. It is also to be understood that method 200 can be implemented on variations of device 101 as well.

At block 201, processor 120 controls camera device 121 to capture a plurality of electronic images at a plurality of focal planes, including, but not limited to, in a burst mode and in a focussing cycle.

At block 203, processor 120 receives, via input device 126, input indicating a selection of one or more of the plurality of focal planes.

At block 205, processor 120 stores an output electronic image at memory 122, the output electronic image comprising one or more of the plurality of electronic images corresponding to one or more selected focal planes.

Non-limiting examples of method 200 will now be described with reference to FIGS. 3 to 11. It is further assumed in the following example that input device 126 comprises a touch screen device at display 124, such that input can be received by receiving touch input at display 124.

FIG. 3 depicts front and rear perspective views of device 101, according to non-limiting implementations. From FIG. 3, it is apparent that camera device 121 is configured to capture electronic images 305 of a field of view at a rear of device 101. It is further apparent that device 101 is in a camera mode such that electronic images 305 captured by camera device 121 are rendered at display 124, including features 304-1, 304-2, 304-3, 304-4 in the field of view. Features 304-1, 304-2, 304-3, 304-4 will be interchangeably referred to hereafter collectively as features 304, and generically as a feature 304. Further, while present implementations are described with reference to four features 304, present implementations are not so limited can include any number of features 304 in a field of view of camera device 121.

It is further appreciated that only an external portion of camera device 121 is depicted in FIG. 3, for example one or more lenses of lens system 140.

It is further appreciated that not all images captured via camera device 121 are stored: indeed, electronic images 305 at display 124 can comprise a series of electronic images and/or a video stream, representing features 304 in a field of view of camera device 121, and a specific electronic image is captured when a shutter command is executed, as will presently be described.

It is further appreciated that, in some implementations, a focus control area 307, can be moved on display 124 to a position that camera device 121 is to focus on when acquiring an electronic image for storage. Focus control area 307 can be moved by receiving input at input device 126 that focus control area 307 is to be moved. Indeed, focus control area 307 can be dragged to any area at display 124, for example to any feature 304, for example by receiving touch input in focus control area 307 for dragging focus control area 307 to a new position on display 124. However, it is appreciated that focus control area 307 is optional. As depicted in FIG. 3, focus control area 307 is located on feature 304-1 rendered at display 124.

Attention is next directed to FIG. 4, which depicts a top perspective view of device 101 and features 304 in a field of view (FOV) 401 of camera device 121. While FOV 401 is represented by two lines radiating outward from device 101, it is appreciated that FOV 401 is conical and that FOV 401 as represented in FIG. 4 is a cross-section thereof.

In any event, features 304 are appreciated to be located in FOV 401, and each feature 304 is located at a respective focal plane 403-1, 403-2, 403-3, 403-4 of camera device 121. Further, a location of each successive feature 304 in FIG. 4 is appreciated to be at a greater distance from device 101 than a previous feature 304. Hence, feature 304-1 is closer to device 101 than feature 304-2, and feature 304-4 is further away from device 101 than feature 304-3. This is also reflected in FIG. 3, in which each successive feature appears in perspective at display 124 from the point of view of camera device 101.

In any event, with reference to FIG. 3, method 200 can be implemented at device 101 by executing a shutter command upon receipt of input data indicative of a shutter command at input device 126. For example, touch input can be received at the touch screen device of display 124 that the shutter command is to be executed (e.g. touch input can be received at display 124 outside of focus control area 307, when present). However, a shutter command can be executed upon receipt of any suitable input, including, but not limited to, an actuation of a button and/or a virtual button associated with a shutter command, and the like.

With reference to FIG. 4, block 201 is then implemented in which camera device 121 is controlled to capture a first electronic image, for example at one of focal planes 403 and/or at another focal plane in FOV 401. In implementations that include focus control area 307, camera device 101 can initially attempt to focus on a feature 304 that is located in focus control area 307, for example feature 304-1. Hence, a plurality of electronic images can be captured, for example in one or more of a burst mode and a focussing cycle with each electronic image processed thereafter by processor 120 to determine if feature 304-1 is in focus before adjusting lens system 140 to a different focal plane to attempt to focus on feature 304-1.

In doing so, each of the plurality of electronic images is captured by camera device 121 with a different focal plane, which can include at one or more of focal planes 403, and the like. However, electronic images captured by camera device 121 can comprise a subset of focussing cycle electronic images, including, but not limited to, every other focussing cycle electronic image, to reduce usage of memory 122.

Alternatively, for example in the absence of focus control area 307, at block 201, lens system 140 can be controlled to step through a plurality of focal planes, acquiring an electronic image at each focal plane, which can include acquiring electronic images at one or more of focal planes 403. For example, lens system 140 can step through a sequence of focal planes, wherein each successive focal plane being further away from device 101 then a previous focal plane or vice versa

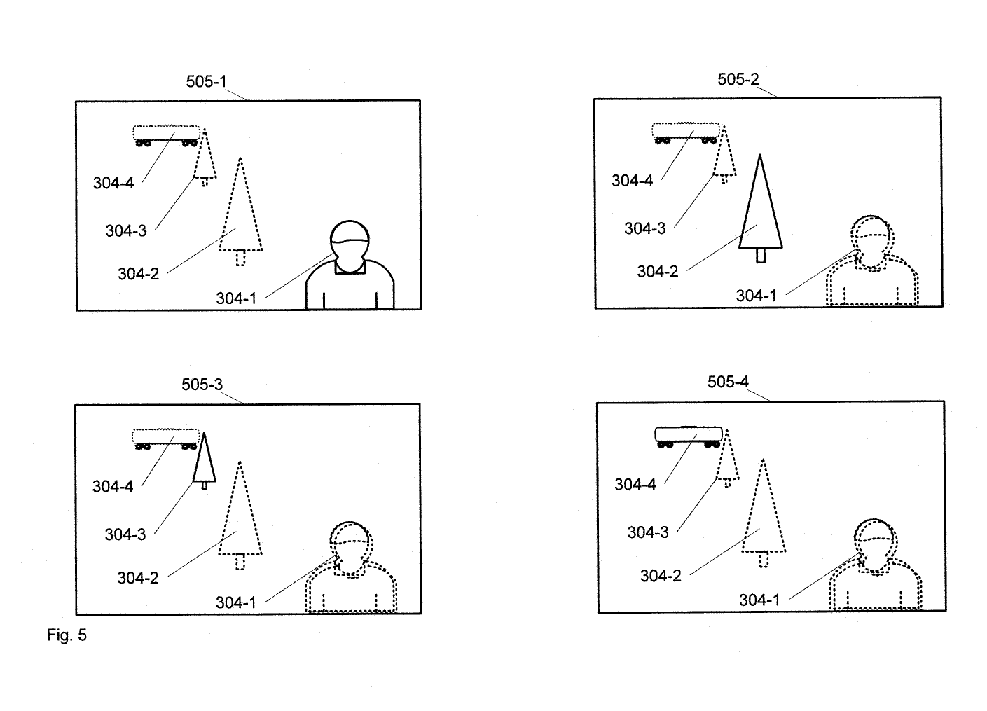

Attention is next directed to FIG. 5, which depicts non-limiting example electronic images 505-1, 505-2, 505-3, 505-4 captured at block 201 of method 200. Electronic images 505-1, 505-2, 505-3, 505-4 will also be interchangeably referred to hereafter, collectively, as electronic images 505 and generically as an electronic image 505.

It is assumed for clarity, in the present non-limiting example, that a combination of a distance between features 304 and an aperture of camera device 121 are such that once camera device 121 focuses on a given focal plane 403 only a corresponding feature 304 is in focus while the remaining features 304 are out of focus.

It is further assumed that the aperture of camera device 121 does not change during block 201.

It is yet further assumed that an electronic image 505 corresponding to each focal plane 403 of FIG. 4 is captured, though present implementations are not so limiting and electronic images 505 corresponding to other focal planes can be captured; further, electronic images 505 for each focal plane 403 need not be captured, and indeed electronic images for an entirely different set of focal planes can be captured.

In any event, in the present non-limiting example, electronic image 505-1 was captured at focal plane 403-1, electronic image 505-2 was captured at focal plane 403-2, electronic image 505-3 was captured at focal plane 403-3, and electronic image 505-4 was captured at focal plane 403-4.

Hence at electronic image 505-1, feature 304-1 is in focus and features 304-2, 304-3, 304-4 are out of focus. Similarly: at electronic image 505-2, feature 304-2 is in focus and features 304-1, 304-3, 304-4 are out of focus: at electronic image 505-3, feature 304-3 is in focus and features 304-1, 304-2, 304-4 are out of focus; and at electronic image 505-4, feature 304-4 is in focus and features 304-1, 304-2, 304-3 are out of focus.

In FIG. 5, features 304 that are in focus are depicted in solid outline while features 304 that are out of focus are depicted in dashed outline.

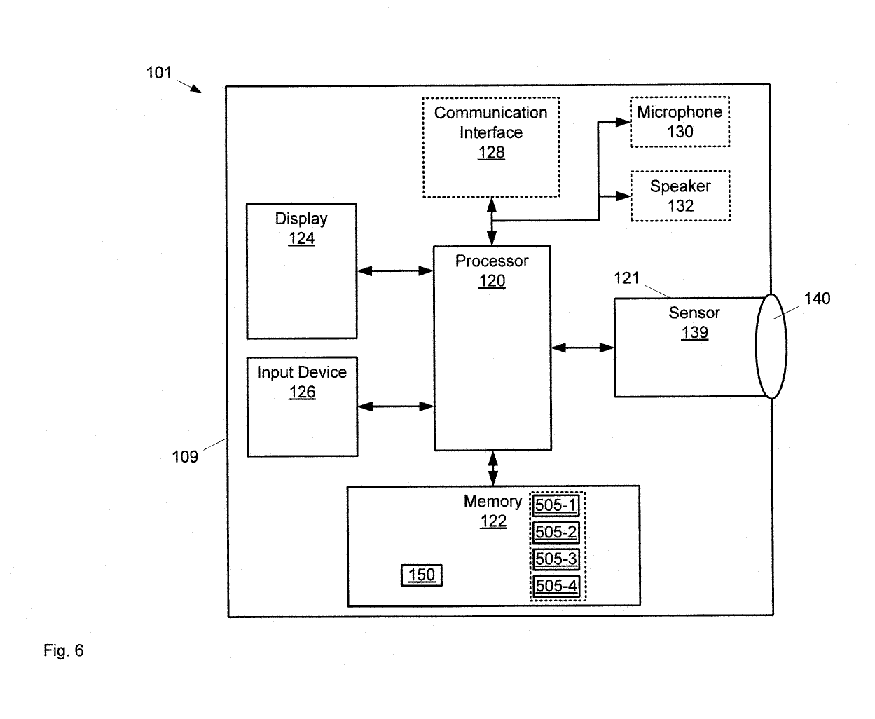

With reference to FIG. 6, which is substantially similar to FIG. 1, with like elements having like numbers, processor 120 can be further configured to store the plurality of electronic images 505 at memory 122 in association with each other, as represented by the dashed line surrounding electronic images 505.

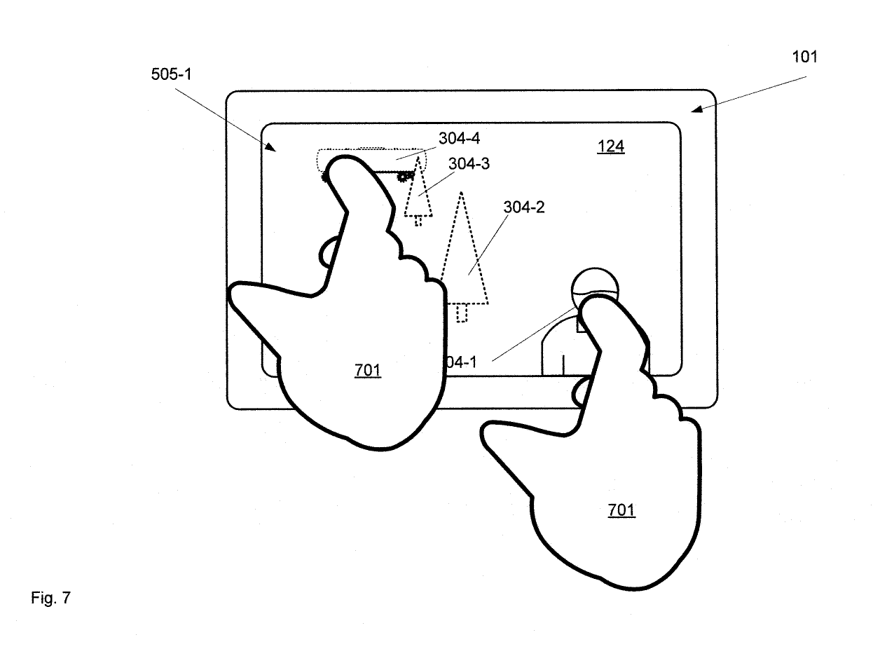

With reference to FIG. 7 (similar to the front view of device 101 depicted in FIG. 3, with like elements having like numbers), initially, one of electronic images 505 can be rendered at display 124, for example electronic image 505-1 corresponding to feature 304-1 being in focus as per a position of focus control area 307 depicted in FIG. 3.

However, in FIG. 7, it is apparent that a hand 701 of a user is further selecting features 304-1, 304-4. Hence, at block 203, processor 120 receives input indicating a selection of one or more of the plurality of focal planes 403, for example via selection of features 304-1, 304-4. Indeed, in depicted implementations, at block 203, processor 120 is further configured to: receive, via the input device 126, input indicating a selection of two or more of the plurality of focal planes 403, for example focal planes 403-1, 403-4 corresponding to features 304-1, 304-4.

While not depicted, electronic image 505-1 can be updated at display 124 to provide an indication of selected features 304-1, 304-4, for example, a box, and the like, can be placed around selected features. Further, features 304 can be deselected by receiving further touch input at a selected feature 304.

However, while in FIG. 7 focal planes 403 and/or features 304 are selected after electronic images 505 are acquired, in yet further implementations processor 120 is further configured to receive input indicative of selection of one or more focal planes 403, via input device 126, one or more of before and after the plurality of electronic images 505 is captured. For example, selection of features to be in focus in an output electronic image could also occur at FIG. 3, with a plurality of focus control areas 307 being provided at display 124; however, in these implementations, the focus control areas 307 are not indicative of a target feature 304 to be in focus but are indicative of a selection of focal planes 403 to be included in electronic image capture at block 201.

It is yet further appreciated that when focus control area 307 was initially used to select a feature 304 and/or focal plane 403 for focusing, as described above, in FIG. 7 a feature 304 and/or focal plane 403 different from that associated with focus control area 307 can be selected. In other words, while in FIG. 7 two focal planes 403 and/or features 304 are selected, in further implementations one focal plane 403 and/or feature 304 can be selected different from that associated with focus control area 307.

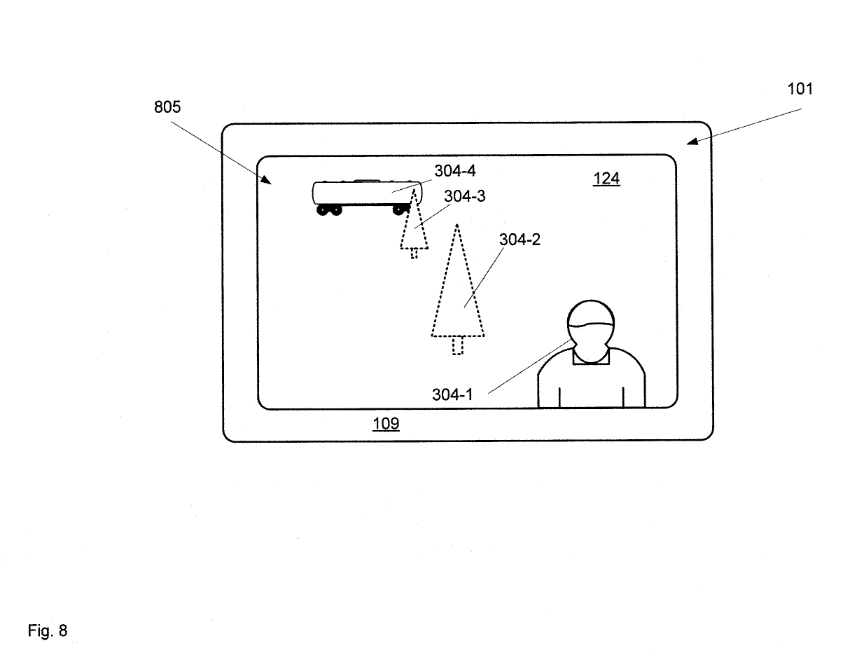

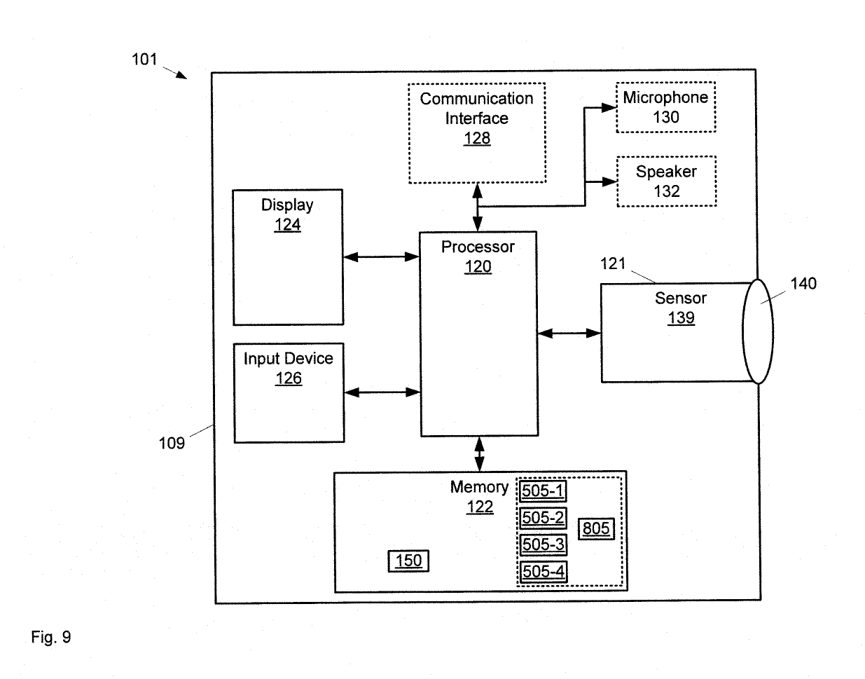

With reference to FIGS. 8 and 9, which are respectively substantially similar to FIGS. 7 and 6, with like elements having like numbers, at block 205, an output electronic image 805 is stored at memory 122, output electronic image 805 comprising one or more of the plurality of electronic images 505 corresponding to one or more selected focal planes 403.

When one focal plane 403 is selected, output electronic image 805 can comprise the electronic image 505 corresponding to the selected focal plane 403.

However, processor 120 can combine two of the plurality of electronic images 505-1, 505-2 respectively corresponding to selected focal planes 403-1, 403-4 (i.e. selected as in FIG. 7 described above) to produce output electronic image 805, wherein features 304-1, 304-4 that are in focus in each of the two of the plurality of electronic images 505-1, 505-4 at each of selected focal planes 403-1, 403-2 are also in focus in output electronic image 805. Features 304-2, 304-3 are correspondingly out of focus.

Further, as in FIG. 9, output electronic image 805 is stored in association with electronic images 505 such that one or more further output electronic images can be generated with other focal planes 403 selected.

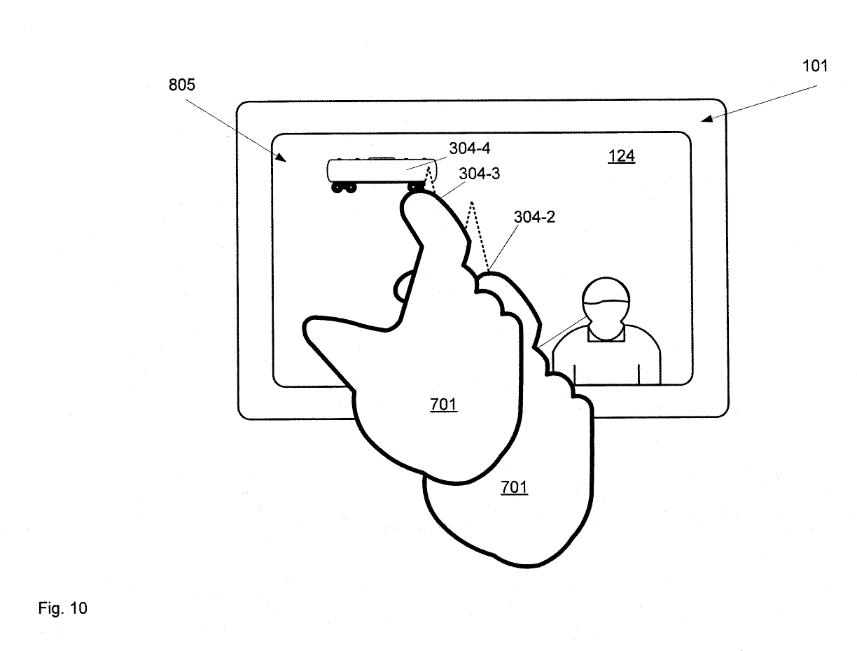

For example, as depicted in FIG. 10, output electronic image 805 can again be rendered at display 124 and features 304-2, 304-3 can be selected, e.g. via hand 701 interacting with display 124. Further, while not depicted, features 304-1, 304-4 can be deselected, as described above.

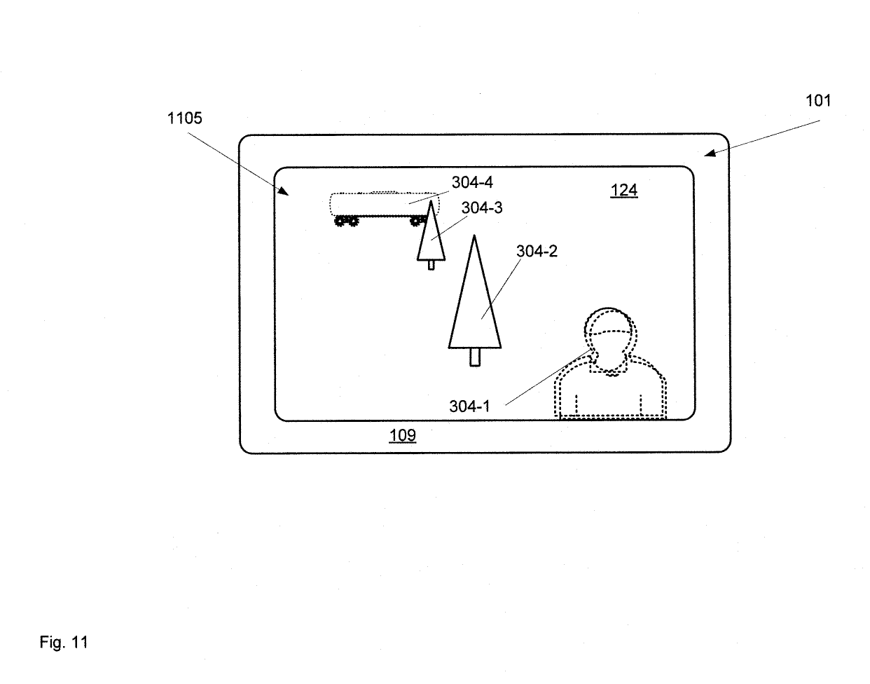

The result is depicted in FIG. 11 (substantially similar to FIG. 10, with like elements having like numbers), where a new output electronic image 1150 is rendered at display 124 (and stored at memory 122, not depicted) however features 304-2, 304-3 are in focus and features 304-1, 304-4 are out of focus. It is further apparent that selecting adjacent features 304 to be in focus effectively increases a virtual aperture of camera device 121 as adjacent features 304-2, 304-3 are both in focus, whereas in electronic images 505, only one of features 304 is in focus in each electronic image 505.

By now, however, it is apparent that any combination of focal planes 403 can be selected, such that any combination of features 304 can be selected to be in focus and/or out of focus. In other words, while an example is provided where two of focal planes 403 are selected, in other implementations more than two of focal planes 403 can be selected, including, but not limited to, all of focal planes 403.

It is further apparent from FIGS. 10 and 11 that input for generation of an output electronic image can be received in a different application than a camera application. For example, as described above at least one application 150 can comprise a camera application for capturing electronic images 505. However, an output electronic image can be generated in an application different from a camera application, for example an image adjustment application stored separately from the camera application at memory 122. In other words, a camera application can be used to initially implement block 201, and an image adjustment application can be used to implement blocks 203, 205, such that capturing of electronic images 505 and generation of output electronic images 805, 1105 occur in different applications at device 101. Hence, in these implementations, processor 120 is further configured to generate output electronic images 805, 1105 by: storing the plurality of electronic images 505 in memory 122 via a camera application; and, receiving input for selecting focal planes 403, via input device 126, in an image adjustment application, different from the camera application, that accesses the plurality of electronic images 505 in memory 122.

Alternatively, in some implementations, electronic images 505 can be transferred to another device (not depicted) for generation of output electronic images 805, 1105. In other words, the image adjustment application can be at a device different from device 101.

Persons skilled in the art will appreciate that there are yet more alternative implementations and modifications possible, and that the above examples are only illustrations of one or more implementations.

For example, camera device 121 can be further adjusted prior to capturing one or more of electronic images 505 to improve quality of one or more of electronic images 505 and/or one or more one or more of electronic images 505 can be processed post-capture to improve quality.

For example, processor 120 can be further configured to control camera device 121 to adjust exposure when capturing one or more of the plurality of electronic images 505 to adjust for lighting at each respective focal plane 403. Such exposure adjustment can depend on lighting of each feature 304; hence, electronic images 505 with a respective feature 304 in focus that is well lit, can be captured with a first exposure time, while electronic images 505 with a respective feature 304 in focus that is not well lit, can be captured with a second exposure time longer than the first exposure time.

However, determination of exposure times can be time consuming, and hence processor 120 can be further configured to control camera device 121 to capture at least two electronic images 505 at respective exposure levels at each of the plurality of focal planes 403. In other words, when camera device 121 is focussed, for example at a given focal plane 403, at block 201, camera device 121 captures two electronic images 505, a first electronic image 505 at a first exposure level and a second electronic image 505 at a second exposure level greater than the first exposure level. One of the two electronic images 505 can be selected for an output electronic image based either on input received at input device 126 to lighten or darken a respective feature and/or automatically based on processor 120 determining which of the two electronic images has a better quality. Such determinations of quality can be based on rules stored at memory 122 and/or whether given features 304 are more visible in given electronic images 505.

In yet further implementations, electronic images 505 can be processed after capture to improve quality thereof. For example, processor 120 can be further configured to apply at least one distortion function to one or more of the plurality of electronic images 505 to adjust for distortion at the plurality of focal planes 403. Such distortion functions can be stored at memory 122, for example in association with at least one application 150.

In any event, controlling a camera device to capture a plurality of electronic images at a plurality of focal planes and storing an output electronic image comprising one or more of the plurality of electronic images corresponding to one or more selected focal planes, the functionality of a plenoptic camera device can virtually implemented without the associated cost of a specialized lens array. Further, as the resolution of each of the plurality of electronic images can use the full resolution of a sensor, there is no loss in resolution in the output electronic image as would occur in a plenoptic camera device. Further, plenoptic camera devices are highly specialized, and generally devoted only to capturing plenoptic images; however, present implementations have no such restrictions and provide the functionality of plenoptic camera devices while remaining versatile; in other words, electronic images can also be acquired outside the virtual plenoptic functionality.

Those skilled in the art will appreciate that in some implementations, the functionality of device 101 can be implemented using pre-programmed hardware or firmware elements (e.g., application specific integrated circuits (ASICs), electrically erasable programmable read-only memories (EEPROMs), etc.), or other related components. In other implementations, the functionality of device 101 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

A portion of the disclosure of this patent document contains material which is subject to copyright protection. The copyright owner has no objection to the facsimile reproduction by anyone of the patent document or patent disclosure, as it appears in the Patent and Trademark Office patent file or records, but otherwise reserves all copyrights whatsoever.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A device comprising:
a processor, a memory, an input device, and a camera device configured to capture at least one electronic image, wherein a focal plane of the camera device is adjustable;
the processor configured to:
control the camera device to capture a plurality of electronic images at a plurality of focal planes;
receive, via the input device, input indicating a selection of one or more of the plurality of focal planes; and,
store an output electronic image at the memory, the output electronic image comprising one or more of the plurality of electronic images corresponding to one or more selected focal planes.

2. The device of claim 1, wherein the processor is further configured to control the camera device to capture the plurality of electronic images at the plurality of focal planes in a burst mode.

3. The device of claim 1, wherein the processor is further configured to store the plurality of electronic images at the memory in association with each other and the output electronic image.

4. The device of claim 1, wherein the input indicates a selection of two or more of the plurality of focal planes and the processor is further configured to:
combine two of the plurality of electronic images respectively corresponding to the selected focal planes to produce the output electronic image, wherein features that are in focus in each of the two of the plurality of electronic images at each of the selected focal planes are also in focus in the output electronic image.

5. The device of claim 1, wherein the processor is further configured to control the camera device to adjust exposure when capturing one or more of the plurality of electronic images to adjust for lighting at each respective focal plane.

6. The device of claim 5, wherein the processor is further configured to control the camera device to capture at least two electronic images at respective exposure levels at one or more of the plurality of focal planes.

7. The device of claim 1, wherein the processor is further configured to receive the input, via the input device, one or more of before and after the plurality of electronic images is captured.

8. The device of claim 1, wherein the processor is further configured to apply at least one distortion function to the plurality of electronic images to adjust for distortion at the plurality of focal planes.

9. The device of claim 1, wherein the processor is further configured to capture the plurality of electronic images in a focussing cycle to focus on a given feature in the plurality of electronic images.

10. The device of claim 9, wherein the plurality of electronic images comprises a subset of focussing cycle electronic images.

11. The device of claim 1, wherein the processor is further configured to generate the output electronic image by:
storing the plurality of electronic images in the memory via a camera application; and,
receiving the input, via the input device, in an image adjustment application different, from the camera application, that accesses the plurality of electronic images in the memory.

12. A method comprising:
at a device comprising a processor, a memory, an input device, and a camera device configured to capture at least one electronic image, wherein a focal plane of the camera device is adjustable, controlling, via the processor, the camera device to capture a plurality of electronic images at a plurality of focal planes;
receiving, via the input device, input indicating a selection of one or more of the plurality of focal planes; and,
storing, via the processor, an output electronic image at the memory, the output electronic image comprising one or more of the plurality of electronic images corresponding to one or more selected focal planes.

13. The method of claim 12, further comprising controlling the camera device to capture the plurality of electronic images at the plurality of focal planes in a burst mode.

14. The method of claim 12, further comprising storing the plurality of electronic images at the memory in association with each other and the output electronic image.

15. The method of claim 12, wherein the input indicates a selection of two or more of the plurality of focal planes, and the method further comprises:
combining two of the plurality of electronic images respectively corresponding to the selected focal planes to produce the output electronic image, wherein features that are in focus in each of the two of the plurality of electronic images at each of the selected focal planes are also in focus in the output electronic image.

16. The method of claim 12, further comprising controlling the camera device to adjust exposure when capturing one or more of the plurality of electronic images to adjust for lighting at each respective focal plane.

17. The method of claim 16, further comprising controlling the camera device to capture at least two electronic images at respective exposure levels at one or more of the plurality of focal planes.

18. The method of claim 12, further comprising receiving the input, via the input device, one or more of before and after the plurality of electronic images is captured.

19. The method of claim 12, further comprising applying at least one distortion function to the plurality of electronic images to adjust for distortion at the plurality of focal planes.

20. The method of claim 12, further comprising capturing the plurality of electronic images in a focussing cycle to focus on a given feature in the plurality of electronic images.

21. The method of claim 20, wherein the plurality of electronic images comprises a subset of focussing cycle electronic images.

22. The method of claim 12, further comprising generating the output electronic image by:
storing the plurality of electronic images in the memory via a camera application; and,
receiving the input, via the input device, in an image adjustment application, different from the camera application, that accesses the plurality of electronic images in the memory.

23. A computer program product, comprising a non-transitory computer usable medium having a computer readable program code adapted to be executed to implement a method comprising:
at a device comprising a processor, a memory, an input device, and a camera device configured to capture at least one electronic image, wherein a focal plane of the camera device is adjustable, controlling, via the processor, the camera device to capture a plurality of electronic images at a plurality of focal planes;
receiving, via the input device, input indicating a selection of one or more of the plurality of focal planes; and,
storing, via the processor, an output electronic image at the memory, the output electronic image comprising one or more of the plurality of electronic images corresponding to one or more selected focal planes.
